(19) United States
(12) Patent Application Publication
(10) Pub. No.: US 2026/0032583 A1
(43) Pub. Date: Jan. 29, 2026

(54) DISCONTINUOUS REST FOR PREDICTABLE TRAFFIC

(71) Applicant: NOKIA OF AMERICA CORPORATION, Murray Hill, NJ (US)

(72) Inventors: Mads LAURIDSEN, Aalborg (DK); Stefano PARIS, Massy (FR); Jorma Johannes KAIKKONEN, Oulu (FI)

(21) Appl. No.: 18/997,153

(22) PCT Filed: Jul. 20, 2022
(86) PCT No.: PCT/US2022/037684

§ 371 Date: Jan. 20, 2025

(51) Int. Cl. H04W 52/02; H04W 72/232; H04W 76/28

(52) U.S. Cl. CPC H04W 52/0216; H04W 72/232; H04W 76/28

(57) ABSTRACT

Systems, methods, apparatuses, and computer program products for discontinuation rest for predictable traffic. One method may include receiving, by a user equipment, a discontinuous rest configuration, and starting, by the user equipment, a discontinuous rest timer indicated by the discontinuous rest configuration upon an end of an active time and if a number of packets transmitted and a number of packets received before the expiration of the active time is smaller than a corresponding threshold indicated in the discontinuous rest configuration. The discontinuous rest timer is associated with a discontinuous reception group.

### TECHNICAL FIELD

Some example embodiments may generally relate to mobile or wireless telecommunication systems, such as Long Term Evolution (LTE), fifth generation (5G) radio access technology (RAT), new radio (NR) access technology, sixth generation (6G), and/or other communications systems. For example, certain example embodiments may relate to systems and/or methods for discontinuation rest for predictable traffic.

### BACKGROUND

Examples of mobile or wireless telecommunication systems may include radio frequency (RF) 5G RAT, the Universal Mobile Telecommunications System (UMTS) Terrestrial Radio Access Network (UTRAN), LTE Evolved UTRAN (E-UTRAN), LTE-Advanced (LTE-A), LTE-A Pro, NR access technology, and/or MulteFire Alliance. 5G wireless systems refer to the next generation (NG) of radio systems and network architecture. A 5G system is typically built on a 5G NR, but a 5G (or NG) network may also be built on E-UTRA radio. It is expected that NR can support service categories such as enhanced mobile broadband (eMBB), ultra-reliable low-latency-communication (URLLC), and massive machine-type communication (mMTC). NR is expected to deliver extreme broadband, ultra-robust, low-latency connectivity, and massive networking to support the Internet of Things (IoT). The next generation radio access network (NG-RAN) represents the RAN for 5G, which may provide radio access for NR, LTE, and LTE-A. It is noted that the nodes in 5G providing radio access functionality to a user equipment (e.g., similar to the Node B in UTRAN or the Evolved Node B (eNB) in LTE) may be referred to as next-generation Node B (gNB) when built on NR radio, and may be referred to as next-generation eNB (NG-eNB) when built on E-UTRA radio.

### SUMMARY

In accordance with some example embodiments, a method may include receiving, by a user equipment, a discontinuous rest configuration. The method may further include starting, by the user equipment, a discontinuous rest timer indicated by the discontinuous rest configuration upon an end of an active time and if a number of packets transmitted and a number of packets received before the expiration of the active time is smaller than a corresponding threshold indicated in the discontinuous rest configuration. The discontinuous rest timer is associated with a discontinuous reception group.

In accordance with certain example embodiments, an apparatus may include means for receiving a discontinuous rest configuration. The apparatus may further include means for starting a discontinuous rest timer indicated by the discontinuous rest configuration upon an end of an active time and if a number of packets transmitted and a number of packets received before the expiration of the active time is smaller than a corresponding threshold indicated in the discontinuous rest configuration. The discontinuous rest timer is associated with a discontinuous reception group.

In accordance with various example embodiments, a non-transitory computer readable medium may be encoded with instructions that may, when executed in hardware, perform a method. The method may include receiving a discontinuous rest configuration. The method may further include starting a discontinuous rest timer indicated by the discontinuous rest configuration upon an end of an active time and if a number of packets transmitted and a number of packets received before the expiration of the active time is smaller than a corresponding threshold indicated in the discontinuous rest configuration. The discontinuous rest timer is associated with a discontinuous reception group.

In accordance with some example embodiments, a computer program product may perform a method. The method may include receiving a discontinuous rest configuration. The method may further include starting a discontinuous rest timer indicated by the discontinuous rest configuration upon an end of an active time and if a number of packets transmitted and a number of packets received before the expiration of the active time is smaller than a corresponding threshold indicated in the discontinuous rest configuration. The discontinuous rest timer is associated with a discontinuous reception group.

In accordance with certain example embodiments, an apparatus may include at least one processor and at least one memory including computer program code. The at least one memory and the computer program code may be configured to, with the at least one processor, cause the apparatus to at least receive a discontinuous rest configuration. The at least one memory and the computer program code may be further configured to, with the at least one processor, cause the apparatus to at least start a discontinuous rest timer indicated by the discontinuous rest configuration upon an end of an active time and if a number of packets transmitted and a number of packets received before the expiration of the active time is smaller than a corresponding threshold indicated in the discontinuous rest configuration. The discontinuous rest timer is associated with a discontinuous reception group.

In accordance with various example embodiments, an apparatus may include circuitry configured to receive a discontinuous rest configuration. The circuitry may further be configured to start a discontinuous rest timer indicated by the discontinuous rest configuration upon an end of an active time and if a number of packets transmitted and a number of packets received before the expiration of the active time is smaller than a corresponding threshold indicated in the discontinuous rest configuration. The discontinuous rest timer is associated with a discontinuous reception group.

In accordance with some example embodiments, a method may include transmitting, by a network entity, a discontinuous rest configuration indicating a discontinuous rest timer to begin upon expiration of an end of an active time associated with a discontinuous reception group and if a number of packets transmitted and a number of packets received before the expiration of the active time is smaller than a corresponding threshold indicated in the discontinuous rest configuration.

In accordance with certain example embodiments, an apparatus may include means for transmitting a discontinuous rest configuration indicating a discontinuous rest timer to begin upon expiration of an end of an active time associated with a discontinuous reception group and if a number of packets transmitted and a number of packets received before the expiration of the active time is smaller than a corresponding threshold indicated in the discontinuous rest configuration.

In accordance with various example embodiments, a non-transitory computer readable medium may be encoded with instructions that may, when executed in hardware, perform a method. The method may include transmitting a discontinuous rest configuration indicating a discontinuous rest timer to begin upon expiration of an end of an active time associated with a discontinuous reception group and if a number of packets transmitted and a number of packets received before the expiration of the active time is smaller than a corresponding threshold indicated in the discontinuous rest configuration.

In accordance with some example embodiments, a computer program product may perform a method. The method may include transmitting a discontinuous rest configuration indicating a discontinuous rest timer to begin upon expiration of an end of an active time associated with a discontinuous reception group and if a number of packets transmitted and a number of packets received before the expiration of the active time is smaller than a corresponding threshold indicated in the discontinuous rest configuration.

In accordance with certain example embodiments, an apparatus may include at least one processor and at least one memory including computer program code. The at least one memory and the computer program code may be configured to, with the at least one processor, cause the apparatus to at least transmit a discontinuous rest configuration indicating a discontinuous rest timer to begin upon expiration of an end of an active time associated with a discontinuous reception group and if a number of packets transmitted and a number of packets received before the expiration of the active time is smaller than a corresponding threshold indicated in the discontinuous rest configuration.

In accordance with various example embodiments, an apparatus may include circuitry configured to transmit a discontinuous rest configuration indicating a discontinuous rest timer to begin upon expiration of an end of an active time associated with a discontinuous reception group and if a number of packets transmitted and a number of packets received before the expiration of the active time is smaller than a corresponding threshold indicated in the discontinuous rest configuration.

### BRIEF DESCRIPTION OF THE DRAWINGS

For a proper understanding of example embodiments, reference should be made to the accompanying drawings, wherein:

FIG. 1 illustrates an example of extended reality (XR) video traffic.

FIG. 2 illustrates an example of matching discontinuous reception (DRX) On Duration with a packet arrival jitter range.

FIG. 3 illustrates an example of discontinuous rest (DRST) applied when packet arrival is after On Duration.

FIG. 4 illustrates an example of a signaling diagram according to certain example embodiments.

FIG. 5 illustrates an example of a flow diagram of a method according to various example embodiments.

FIG. 6 illustrates an example of another flow diagram of a method according to various example embodiments.

FIG. 7 illustrates an example of parameters of a discontinuous rest timer.

FIG. 8 illustrates an example of a probability distribution of a frame arrival and possible connected mode DRX (CDRX) configurations with DRST.

FIGS. 9a-b illustrate power saving gains of four schemes according to some example embodiments.

FIG. 10 illustrates an example of various network devices according to some example embodiments.

FIG. 11 illustrates an example of a 5G network and system architecture according to certain example embodiments.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for discontinuation rest for predictable traffic is not intended to limit the scope of certain example embodiments, but is instead representative of selected example embodiments.

As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

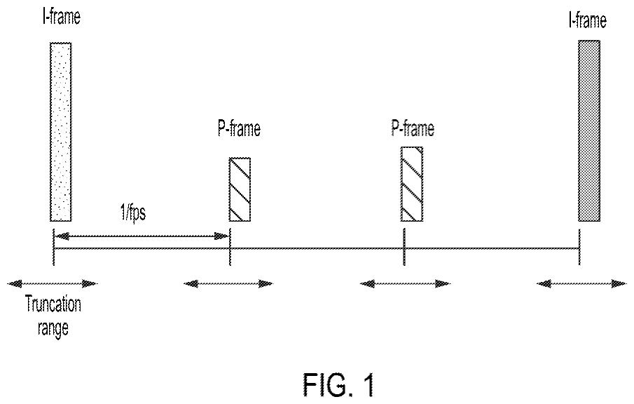

XR downlink traffic may primarily include video frames, as shown in FIG. 1. Specifically, the arrival process of XR traffic at a base station may be characterized as a quasi-periodic process, with a period associated with a video frame rate, and a jitter that may be modelled as a truncated Gaussian distribution. For example, with a 60 frame per second (fps) video, the average interarrival time would be 1/60 fps=16.67 ms, with jitter of Oms mean and a standard deviation of 2 ms. The truncated distribution's range would then be +/−4 ms. Thus, the packet may be expected to arrive within a window of 8 ms, followed by a window of silence of 8 ms, as illustrated in FIG. 1.

DRX and physical downlink control channel (PDCCH) monitoring techniques have been studied with respect to XR and general UE power saving. For example, some techniques have been discussed on adaptive DRX and dynamic control of DRX, where parameters of the DRX cycle can be dynamically adapted through layer 1 (L1) and layer 2 (L2) signalling. Improvements to UE power saving have included techniques with the DRX wake-up signal (e.g., dynamic clustering protocol (DCP): downlink control information (DCI) with cyclic redundancy check (CRC) scrambled by power saving-radio network temporary identifier (PS-RNTI), PDCCH monitoring adaptation schemes based on search space set group (SSSG) switching, and PDCCH monitoring skipping indication via DCI.

However, none of the existing UE power saving techniques are related to XR traffic, and many enhancements to XR have only considered the possibility to shorten the active period of the DRX cycle when a frame has been correctly received. This would require a relatively long On Duration that is shortened with L1/L2 signalling and/or conditions. However, a long On Duration may result in wasted UE energy since the frame frequently is fully delivered before the end of the jitter range, which may be defined by the On Duration. The continuous signaling for shortening the On Duration from the network to the UE may cause higher signalling overheard since the network may need to signal when the frame has been fully transmitted.

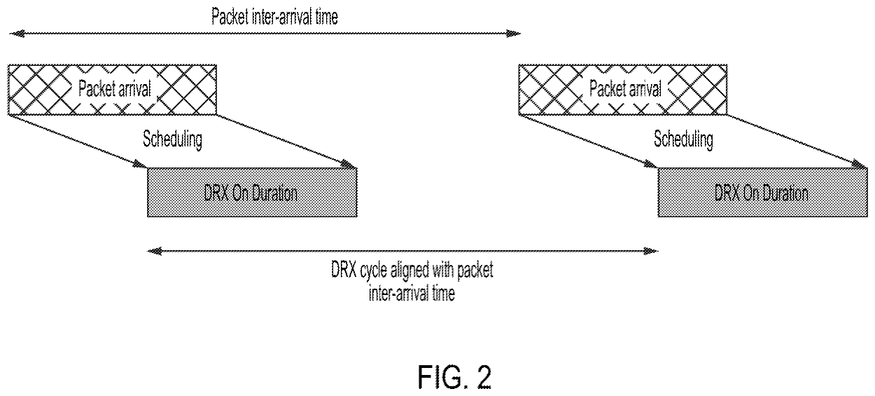

The Truncated Gaussian distribution may allow the packet arrival to be known to happen within the truncated range, and with a periodicity according to the frame arrival rate. Furthermore, there may be a packet delay budget requirement of 10 ms or 15 ms for XR. Due to the jitter of the packet arrival, the DRX On Duration may not be limited without violating the packet delay budget. However, a long On Duration may increase the UE energy consumption since the UE may need to monitor PDCCH during the On Duration. FIG. 2 illustrates how the duration of the On Duration may be matched to the packet arrival jitter to ensure that the network is able to schedule the packet to the UE within the packet delay budget.

To improve the UE power saving gain of DRX for predictable traffic like XR, a Discontinuous Rest (DRST) scheme allows an On Duration timer to be extended when no traffic has been received when the On Duration timer has expired. Certain example embodiments of DRST described herein may have various benefits and/or advantages to overcome the disadvantages described above. For example, certain example embodiments may allow the UE to be configured with a short On Duration whenever the video frame arrives within the On Duration, thereby saving energy. Furthermore, the base station may not need to predict when the video frame transfer has been completed because the UE will automatically extend PDCCH monitoring until it has received the video frame. In addition, the UE may automatically fix the time drift between DRX and frame arrival time due to the non-integer periodicity of the XR traffic. Time drift may eventually cause the On Duration to fall outside the expected frame arrival interval; extending the On Duration may avoid the loss of the frame. Thus, certain example embodiments discussed below are directed to improvements in computer-related technology.

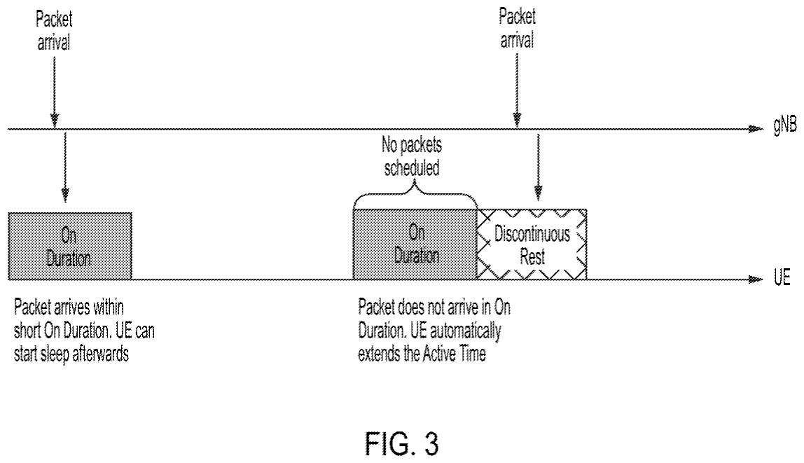

Some example embodiments discussed herein may relate to a DRST parameter applied when a packet arrives after an On Duration period, as shown in FIG. 3. Specifically, a UE and base station may agree to transmit XR traffic according to certain characteristics. One key characteristic is the number of video frames expected to arrive per DRX Active Time instance, for example, 1 video frame per configured DRX cycle. Although certain example embodiments herein are described in terms of XR type of traffic, various example embodiments are generally applicable to traffic with predictable arrival patterns, where the UE and NE can agree on a number of expected packets within a time duration.

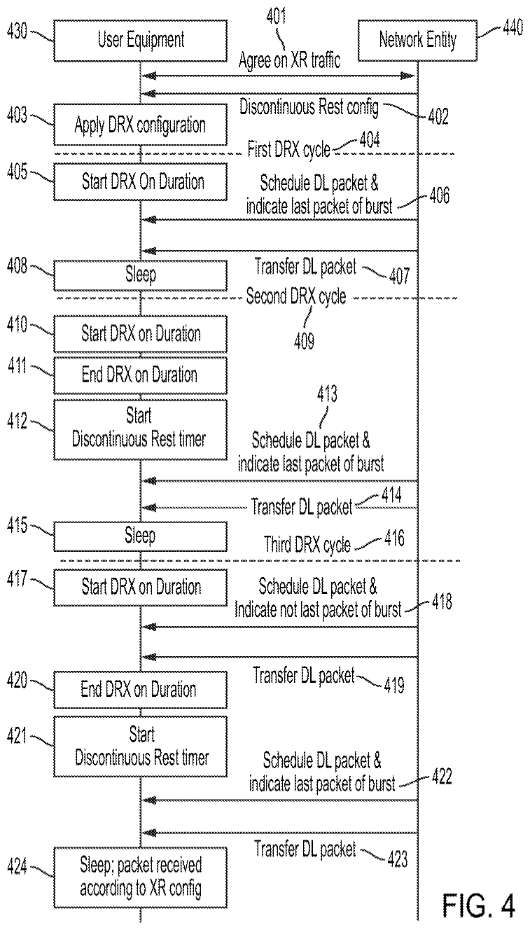

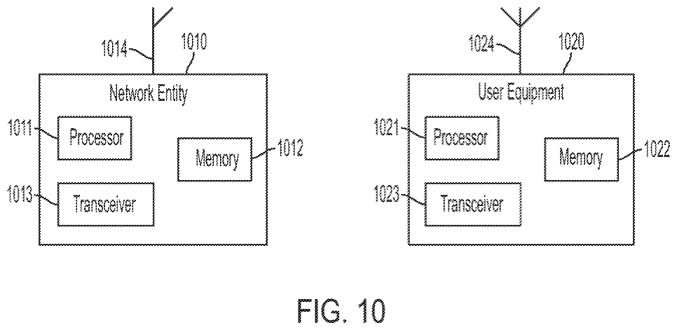

FIG. 4 illustrates an example of a signaling diagram depicting for discontinuation rest for predictable traffic. UE 430 and NE 440 may be similar to UE 1020 and NE 1010, as illustrated in FIG. 10, according to certain example embodiments. In various example embodiments, UE 430 may automatically extend PDCCH monitoring based on a DRST configuration.

At 401, UE 430 and NE 440 may agree on XR traffic parameters. For example, this may be performed using RRC signaling during RRC Connection Setup or RRC Reconfiguration procedures. Alternatively, this may be performed by extending the PDU session establishment procedure: XR traffic parameters are exchanged between UE and AMF during PDU session establishment. Once the PDU session has been established, AMF signals the traffic parameters to RAN.

At 402, NE 440 may transmit to UE 430 an RRC information element that indicates that DRST is active and/or time-related parameters and/or threshold(s) indicating the number of expected packets to be transmitted/received during the DRX cycle. For example, the time-related parameters may indicate an On Duration (e.g., covering ¼ or ½ of a jitter range), and a DRST extension timer value. The DRST extension timer value may run until the video frame is received (i.e., one slot at a time) according to a specific timer value (Inactivity Timer), an indication from NE 440, or until a next On Duration. In some example embodiments, the Inactivity Timer may not be configured or may be limited to a short value when DRST is configured.

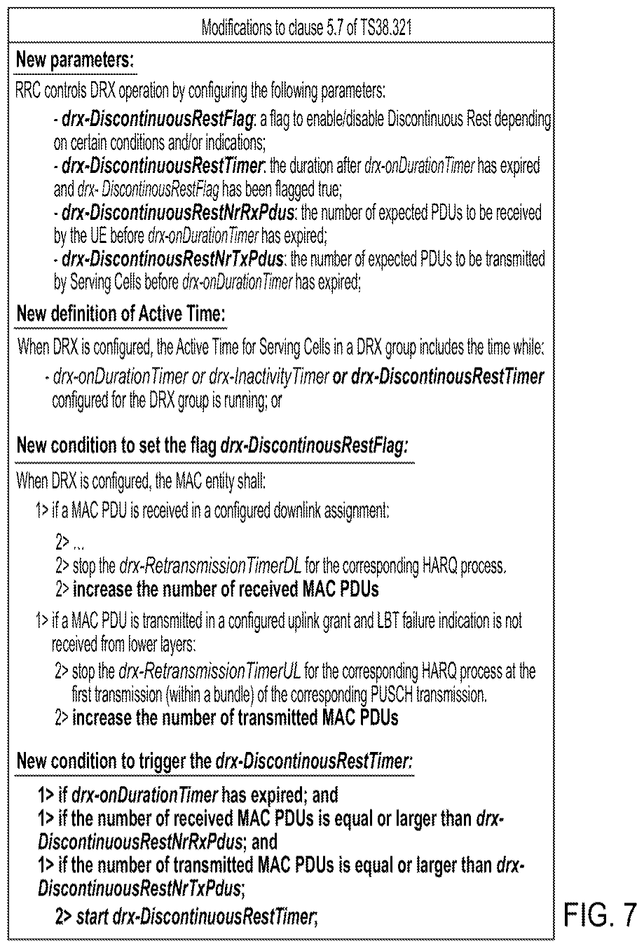

As noted above, DRST may be implemented as a timer that is triggered ifno packet has been received yet or if the number of received packets is smaller than the expected number of packets to be transmitted and/or received during the DRX cycle, and the drx-OnDuration timer has expired. As an example, MAC may be amended to include DRST in order to define parameters like the duration of the “Discontinuous Rest” timer, conditions for its activation/deactivation (e.g., if the number of received packets is smaller than the expected number of packets to be transmitted and/or received during the DRX cycle), and the interaction with other DRX procedures, which be similar to the parameters shown in FIG. 7. The DRST parameters may be associated with a DRX group; for example, the DRX group may have DRST parameters specific to each DRX group for a single set of, or all, DRST parameters. In addition, two DRX groups may be associated with two dedicated DRX configurations (i.e., each group may have its own DRX parameters such as OnDuration and Inactivity Timer). The DRST parameters may include enabled/disabled, extension timer, and number of expected packets.

At 403, UE 430 may apply the received DRX configuration.

At 404, UE 430 and NE 440 may enter a first DRX cycle.

At 405, UE 430 may start DRX according to the On Duration parameter. UE 430 may monitor PDCCH according to the On Duration.

At 406, NE 440 may transmit a schedule DL packet to UE 430, and indicate to UE 430 that the schedule DL packet is the last packet of a burst. An end of burst indication, such as a bit carried in the DCI command or in the packet header, may be used to indicate that the packet is the last one of a burst.

In some example embodiments, an L1/L2 signal (either DCI or MAC CE command) may be used by NE 440 to enable and/or disable the DRST behavior. This may enable NE 440 to detect boundaries of a delay-limited burst of packets (e.g., packets that belong to the same video frame). If the packet is the last of the burst, NE 440 may indicate to UE 430 that no further packet is expected, and UE 430 may disable the DRST timer. NE 440 may signal the scheduling information on PDDCH if this is the last packet of the burst (i.e., whether no further transmissions are expected until the next DRX cycle). This information can be used by UE 430 to increase a counter of the number of received packets, which together with drx-DiscontinousRestNrRxPdus, the number of transmitted packets, and drx-DiscontinousRestNrTxPdus may be used to determine whether drx-DiscontinousRestTimer should be started after the drx-onDurationTimer expires.

In various example embodiments, NE 440 may trigger the DRST by use of a DCI without scheduling information. For example, NE 440 may not schedule UE 430 during the On Duration, but if NE 440 may estimate that data will arrive shortly thereafter, NE 440 may transmit DCI to trigger the DRST (or Inactivity Timer if configured) to ensure that UE 430 monitors PDCCH after the expiry of the On Duration. Additionally or alternatively, group common physical downlink control channel (GC-PDCCH) may be used to address multiple UEs for such an extension.

At 407, NE 440 may transmit a transfer DL packet to UE 330.

At 408, UE 430 may enter a sleep mode. For example, if a video frame is received within the On Duration or if all expected packets have been successfully received within the On Duration, UE 430 may enter sleep earlier than without On Duration since the On Duration is relatively short.

At 409, UE 430 and NE 440 may enter a second DRX cycle.

At 410, UE 430 may start DRX according to the On Duration parameter. For example, if UE 430 does not receive a video frame within the On Duration or if the number of received packets within the On Duration is smaller than the expected number of packets to be transmitted/received during the DRX cycle, UE 430 may automatically extend the DRX Active Time, specifically, DRST according to the configured extension timer. In addition, NE 440 may monitor how often the DRST is needed, and may adjust the On Duration with UE 430.

At 411, UE 430 may end DRX according to the On Duration parameter.

At 412, UE 430 may start a ‘Discontinuous Rest’ timer.

At 413, NE 440 may transmit a schedule DL packet to UE 430, and indicate to UE 430 that the schedule DL packet is the last packet of a burst. An end of burst indication, such as a bit carried in the DCI command or in the packet header, may be used to indicate that the packet is the last one of a burst.

At 414, NE 440 may transmit a transfer DL packet to UE 430.

At 415, UE 430 may enter a sleep mode. For example, if a video frame is received within the On Duration or if all expected packets have been successfully received within the On Duration, UE 430 may enter sleep earlier than without On Duration since the On Duration is relatively short.

At 416, UE 430 and NE 440 may enter a second DRX cycle.

At 417, UE 430 may start DRX according to the On Duration parameter. For example, if UE 430 does not receive a video frame within the On Duration or if the number of received packets within the On Duration is smaller than the expected number of packets to be transmitted/received during the DRX cycle, UE 430 may automatically extend the DRX Active Time, specifically, DRST according to the configured extension timer.

At 418, NE 440 may transmit a schedule DL packet to UE 430, and indicate to UE 430 that the schedule DL packet is the last packet of a burst. An end of burst indication, such as a bit carried in the DCI command or in the packet header, may be used to indicate that the packet is the last one of a burst.

At 419, NE 440 may transmit a transfer DL packet to UE 430.

At 420, UE 430 may end DRX according to the On Duration parameter.

At 421, UE 430 may start a ‘Discontinuous Rest’ timer.

At 422, NE 440 may transmit a schedule DL packet to UE 430, and indicate to UE 430 that the schedule DL packet is the last packet of a burst. An end of burst indication, such as a bit carried in the DCI command or in the packet header, may be used to indicate that the packet is the last one of a burst.

At 423, NE 440 may transmit a transfer DL packet to UE 430.

At 424, UE 430 may enter a sleep mode, and the transfer DL packet may be received according to the XR traffic configuration.

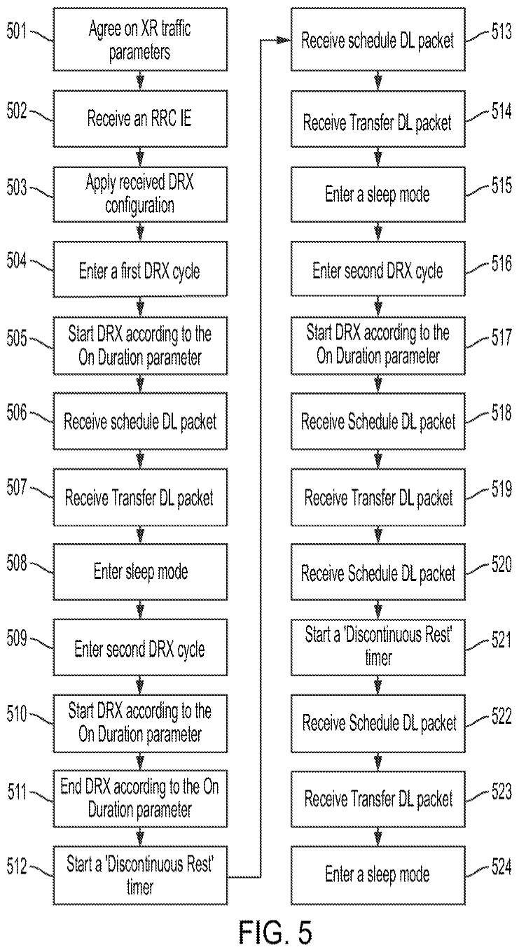

FIG. 5 illustrates an example of a flow diagram of a method that may be performed by a UE, such as UE 1020 illustrated in FIG. 10, according to various example embodiments.

At 501, the method may include agreeing on XR traffic parameters with a NE, such as NE 1010 illustrated in FIG. 10. For example, this may be performed using RRC signaling during RRC Connection Setup or RRC Reconfiguration procedures. Alternatively, this may be performed by extending the PDU session establishment procedure: XR traffic parameters are exchanged between UE and AMF during PDU session establishment. Once the PDU session has been established AMF signals the traffic parameters to RAN.

At 502, the method may include receiving from the NE an RRC IE that indicates that DRST is active and/or time-related parameters and/or threshold(s) indicating the number of expected packets to be transmitted during the DRX cycle. For example, the time-related parameters may indicate an On Duration (e.g., covering ¼ or ½ of a jitter range), and a DRST extension timer value. The DRST extension timer value may run until the video frame is received (i.e., one slot at a time) according to a specific timer value (Inactivity Timer), an indication from the NE, or until a next On Duration. In some example embodiments, the Inactivity Timer may not be configured or may be limited to a short value when DRST is configured.

As noted above, DRST may be implemented as a timer that is triggered ifno packet has been received yet or if the number of received packets is smaller than the expected number of packets to be transmitted/received during the DRX cycle, and the drx-OnDuration timer has expired. As an example, MAC may be amended to include DRST in order to define parameters like the duration of the “Discontinuous Rest” timer, conditions for its activation/deactivation (e.g., if the number of received packets is smaller than the expected number of packets to be transmitted and/or received during the DRX cycle), and the interaction with other DRX procedures, which be similar to the parameters shown in FIG. 7. The DRST timer may be associated with a DRX group; for example, the DRX group may have DRST parameters specific to each DRX group for a single set of, or all, DRST parameters. In addition, two DRX groups may be associated with two dedicated DRX configurations (i.e., each group may have its own DRX parameters such as OnDuration and Inactivity Timer). The DRST parameters may include enabled/disabled, extension timer, and number of expected packets.

At 503, the method may include applying the received DRX configuration.

At 504, the method may include entering a first DRX cycle with the NE.

At 505, the method may include starting DRX according to the On Duration parameter. The UE may monitor PDCCH according to the On Duration.

At 506, the method may include receiving a schedule DL packet from the NE, and receiving an indication from the NE that the schedule DL packet is the last packet of a burst. An end of burst indication, such as a bit carried in the DCI command or in the packet header, may be used to indicate that the packet is the last one of a burst.

In some example embodiments, an L1/L2 signal (either DCI or MAC CE command) used by the network to enable and disable the DRST behavior. This may enable the network to detect boundaries of a delay-limited burst of packets (e.g., packets that belong to the same video frame). If the packet is the last of the burst, the UE may receive from the NE an indication that no further packet is expected, and the UE may disable the DRST timer. The UE may receive from the NE scheduling information on PDDCH if this is the last packet of the burst (i.e., whether no further transmissions are expected until the next DRX cycle). This information may be used by the UE to increase a counter of the number of received packets, which together with drx-DiscontinousRestNrRxPdus, the number of transmitted packets, and drx-DiscontinousRestNrTxPdus may be used to determine whether drx-DiscontinousRestTimer may be started after the drx-onDurationTimer expires.

In various example embodiments, the UE may receive from the NE a trigger of the DRST by use of a DCI without scheduling information. For example, the UE may not be scheduled by the NE during the On Duration, but if the NE estimates that data will arrive shortly thereafter, the UE may receive DCI to trigger the DRST (or Inactivity Timer if configured) to ensure that the UE monitors PDCCH after the expiry of the On Duration. Additionally or alternatively, GC-PDCCH may be used to address multiple UEs for such an extension.

At 507, the method may include receiving a transfer DL packet from the NE. At 508, the method may include entering a sleep mode. For example, if a video frame is received within the On Duration or if all expected packets have been successfully received within the On Duration, the UE may enter sleep earlier than without On Duration since the On Duration is relatively short.

At 509, the method may include entering a second DRX cycle with the NE. At 510, the method may include starting DRX according to the On Duration parameter. For example, if the UE does not receive a video frame within the On Duration or if the number of received packets within the On Duration is smaller than the expected number of packets to be transmitted/received during the DRX cycle, the UE may automatically extend the DRX Active Time, specifically, DRST according to the configured extension timer. In addition, the NE may monitor how often the DRST is needed, and may adjust the On Duration with the UE.

At 511, the method may include ending DRX according to the On Duration parameter. At 512, the method may include starting a ‘Discontinuous Rest’ timer. At 513, the method may include receiving a schedule DL packet from the NE, and receiving an indication that the schedule DL packet is the last packet of a burst. An end of burst indication, such as a bit carried in the DCI command or in the packet header, may be used to indicate that the packet is the last one of a burst.

At 514, the method may include receiving a transfer DL packet from the NE.

At 515, the method may include entering a sleep mode. For example, if a video frame is received within the On Duration or if all expected packets have been successfully received within the On Duration, the UE may enter sleep earlier than without On Duration since the On Duration is relatively short.

At 516, the method may include entering a second DRX cycle with the NE.

At 517, the method may include starting DRX according to the On Duration parameter. For example, if the UE does not receive a video frame within the On Duration or if the number of received packets within the On Duration is smaller than the expected number of packets to be transmitted/received during the DRX cycle, the UE may automatically extend the DRX Active Time, specifically, DRST according to the configured extension timer.

At 518, the method may include receiving a schedule DL packet from the NE, and receiving an indication that the schedule DL packet is the last packet of a burst. An end of burst indication, such as a bit carried in the DCI command or in the packet header, may be used to indicate that the packet is the last one of a burst.

At 519, the method may include receiving a transfer DL packet from the NE.

At 520, the method may include receiving a schedule DL packet from the NE, and receiving an indication that the schedule DL packet is the last packet of a burst. An end of burst indication, such as a bit carried in the DCI command or in the packet header, may be used to indicate that the packet is the last one of a burst.

At 521, the method may include starting a ‘Discontinuous Rest’ timer.

At 522, the method may include may receiving a schedule DL packet from the NE, and receiving an indication that the schedule DL packet is the last packet of a burst. An end of burst indication, such as a bit carried in the DCI command or in the packet header, may be used to indicate that the packet is the last one of a burst.

At 523, the method may include receiving a transfer DL packet from the NE.

At 524, the method may include entering a sleep mode, and receiving the transfer DL packet according to the XR traffic configuration.

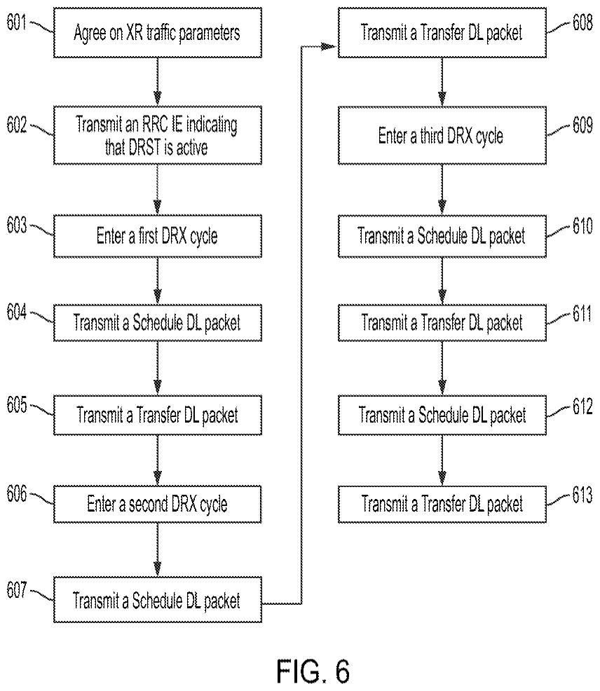

FIG. 6 illustrates an example of a flow diagram of a method that may be performed by a NE, such as NE 1020 illustrated in FIG. 10, according to various example embodiments.

At 601, the method may include agreeing on XR traffic parameters with a UE, such as UE 1020 illustrated in FIG. 10. For example, this may be performed using RRC signaling during RRC Connection Setup or RRC Reconfiguration procedures. Alternatively, this may be performed by extending the PDU session establishment procedure: XR traffic parameters are exchanged between UE and AMF during PDU session establishment. Once the PDU session has been established, AMF signals the traffic parameters to RAN.

At 602, the method may include transmitting to the UE an RRC information element that indicates that DRST is active and/or time-related parameters and/or threshold(s) indicating the number of expected packets to be transmitted/received during the DRX cycle. For example, the time-related parameters may indicate an On Duration (e.g., covering ¼ or ½ of a jitter range), and a DRST extension timer value. The DRST extension timer value may run until the video frame is received (i.e., one slot at a time) according to a specific timer value, the Inactivity Timer, an indication to the UE, or until a next On Duration. In some example embodiments, the Inactivity Timer may not be configured or may be limited to a short value when DRST is configured.

As noted above, DRST may be implemented as a timer that is triggered ifno packet has been received yet or if the number of received packets is smaller than the expected number of packets to be transmitted/received during the DRX cycle, and the drx-OnDuration timer has expired. As an example, MAC may be amended to include DRST in order to define parameters like the duration of the “Discontinuous Rest” timer, conditions for its activation/deactivation (e.g., if the number of received packets is smaller than the expected number of packets to be transmitted and/or received during the DRX cycle), and the interaction with other DRX procedures, which be similar to the parameters shown in FIG. 7. The DRST parameters may be associated with a DRX group; for example, the DRX group may have DRST parameters specific to each DRX group for a single set of, or all, DRST parameters. In addition, two DRX groups may be associated with two dedicated DRX configurations (i.e., each group may have its own DRX parameters such as OnDuration and Inactivity Timer). The DRST parameters may include enabled/disabled, extension timer, and number of expected packets.

At 603, the method may include entering a first DRX cycle with the UE.

At 604, the method may include transmitting a schedule DL packet to the UE, and indicating to the UE that the schedule DL packet is the last packet of a burst. An end of burst indication, such as a bit carried in the DCI command or in the packet header, may be used to indicate that the packet is the last one of a burst.

In some example embodiments, an L1/L2 signal (either DCI or MAC CE command) used by the network to enable and disable the DRST behavior. This may enable the network to detect boundaries of a delay-limited burst of packets (e.g., packets that belong to the same video frame). If the packet is the last of the burst, the NE may indicate to the UE that no further packet is expected, and the UE can disable the DRST timer. The NE may signal the scheduling information on PDDCH if this is the last packet of the burst (i.e., whether no further transmissions are expected until the next DRX cycle). This information can be used by the UE to increase a counter of the number of received packets, which together with drx-DiscontinousRestNrRxPdus, the number of transmitted packets, and drx-DiscontinousRestNrTxPdus is used to determine whether drx-DiscontinousRestTimer may be started after the drx-onDurationTimer expires.

In various example embodiments, the NE may trigger the DRST by use of a DCI without scheduling information. For example, the NE may not schedule the UE 430 during the On Duration, but estimates data will arrive shortly thereafter, the NE may transmit DCI to trigger the DRST (or Inactivity Timer if configured) to ensure that the UE monitors PDCCH after the expiry of the On Duration. Additionally or alternatively, GC-PDCCH may be used to address multiple UEs for such an extension.

At 605, the method may include transmitting a transfer DL packet to the UE.

At 606, the method may include entering a second DRX cycle with the UE.

At 607, the method may include transmitting a schedule DL packet to the UE, and indicating to the UE that the schedule DL packet is the last packet of a burst. An end of burst indication, such as a bit carried in the DCI command or in the packet header, may be used to indicate that the packet is the last one of a burst.

At 608, the method may include transmitting a transfer DL packet to the UE.

At 609, the method may include entering a third DRX cycle with the UE.

At 610, the method may include transmitting a schedule DL packet to the UE, and indicating to the UE that the schedule DL packet is the last packet of a burst. An end of burst indication, such as a bit carried in the DCI command or in the packet header, may be used to indicate that the packet is the last one of a burst.

At 611, the method may include transmitting a transfer DL packet to the UE.

At 612, the method may include transmitting a schedule DL packet to the UE, and indicating to the UE that the schedule DL packet is the last packet of a burst. An end of burst indication, such as a bit carried in the DCI command or in the packet header, may be used to indicate that the packet is the last one of a burst.

At 613, the method may include transmitting a transfer DL packet to the UE.

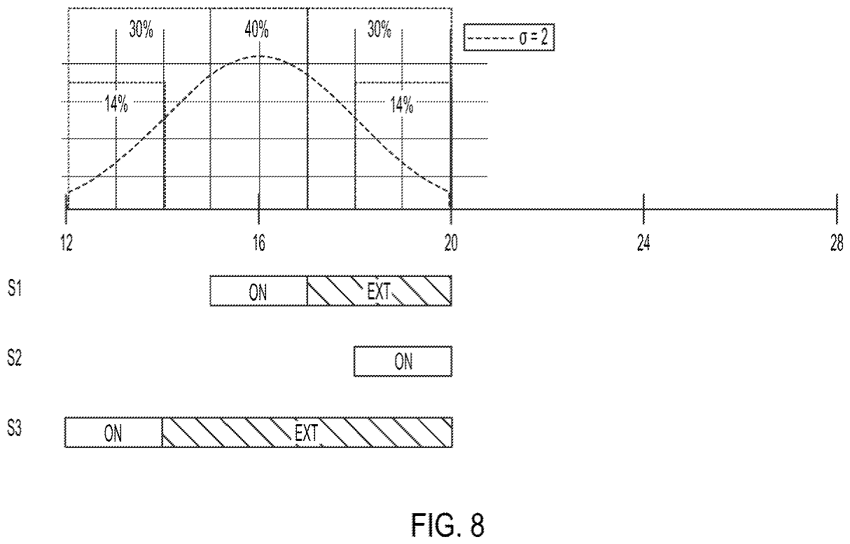

FIG. 8 depicts a probability distribution of a frame arrival process to model random jitter (e.g., truncated Gaussian distribution centred around the arrival time), and three configurations of DRX with DRST. In all three configurations, the long duration may be 16 ms, and the DRX cycle may starts at 12 and end at 28.

The three configurations may include S1, wherein DRST extends the On Duration only in 30% of the cases. XR frames that arrive between 12 to 15 may be delayed by at most 3 ms. The three configurations may also include S2, which does not trigger the extension of the On Duration except when time drift causes the XR frame to fall after the On Duration, which may require reconfiguration of the DRX cycle if the drift grows too large. However, this configuration may also introduce 6 ms of extra-delay for frames that arrive at 12, thereby preventing HARQ retransmission in case of error since the delay budget is rather limited for XR services (e.g., 10 ms for AR/VR applications).

The three configurations may also include S3; in 86% of the cases, On Duration may be extended. There may be some benefit in having a DRX configuration which starts at 12 and ends at 20, since in 14% of the cases, DRST does not need to extend the On Duration. Thus, DRST may add flexibility to easily configure DRX, with trade-offs between user satisfaction and power saving. With respect to S2 in FIG. 6, DRST may rarely extend the On Duration.

As explained above, certain embodiments may provide advantages in terms of power saving gains. In one example, 100, 280, and 300 units of power may be consumed by a UE for monitoring each slot for the PDCCH, decoding symbols of the PDSCH, and PDCCH+PDSCH decoding, respectively. Performance may be evaluated corresponding to subcarrier spacing of 30 kHz and slot duration of 0.5 ms, and XR traffic may also be modelled. Video frames may be generated with a constant frame rate of 60 fps, which may correspond to a period of 16.67 ms between two consecutive frames. A random variable distributed as a Truncated Gaussian distribution may also be added to the constant period to model the jitter. The truncated Gaussian distribution may then have 0 mean, 2 ms as standard deviation, and range equal to [−4;4]ms.

Four schemes may be used for analysis, including 1) CDRX with LongCycle=16 ms and OnDuration=8 ms; 2) CDRX with LongCycle=16 ms and OnDuration=12 ms; 3) CDRX with LongCycle=16 ms and OnDuration=4 ms and DRST; and 4) CDRX with LongCycle=16 ms and OnDuration=6 ms and DRST.

The second CDRX configuration may have an OnDuration larger than the jitter rage (i.e., 12 ms>8 ms) since XR frame arrivals drift away from the CDRX cycle. The XR frame arrival process may also have an average interarrival time of 16.67 ms, while the CDRX LongCycle may be equal to 16 ms. The misalignment of 0.67 ms between XR arrivals and CDRX cycle may result in time drift that accumulates over time. The larger OnDuration may mitigate the time drift. In addition, DRST may have been configured only for the 3^{rd} and 4^{th} DRX schemes, which have an OnDuration shorter than the expected interval of the frame arrival (i.e., the jitter range).

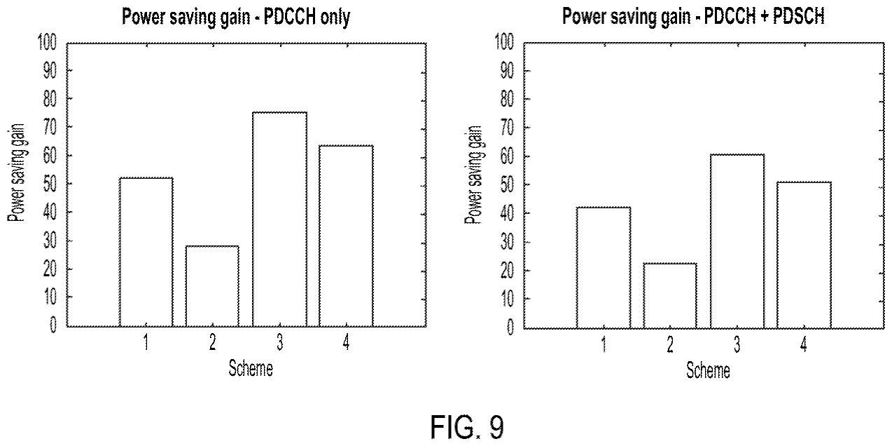

The four schemes may be compared according to power saving gain with respect to a UE “Always ON,” specifically, a UE with all power saving features disabled. The power saving gain may be computed according to

$$γ = 1 - \frac{{P}_{P S}}{{P}_{B}} ,$$

where PPS is the average power consumed by all UEs with power saving scheme enabled, and PB is the average power consumed by a UE “Always ON.” FIG. 9a depicts the power saving gain of the four schemes measured considering only the power consumed for the PDCCH, and similarly, FIG. 9b for the PDCCH+PDSCH. In FIGS. 9a-b, the schemes are shown with DRST achieving the larger power saving gain among the four schemes. In particular, with only the PDCCH, DRX(16,4) and DRX(16,6), coupled with DRST, may reduce the power of monitoring the PDCCH by 75% and 65%, respectively. In contrast, DRX(16,8) and DRX(16,12) may only reduce the PDCCH monitoring power by up to 50% and 25%. In addition, based upon the power spent to decode the frame transmission (PDSCH decoding power), the power saving gain decreases for all schemes, yet the saved power remains non-negligible and the relative gains among the four schemes are roughly the same.

The larger power saving gain of DRST schemes 3 and 4 may be due to the shorter OnDuration, which may be extended rarely by the DRST mechanism. Indeed, a short OnDuration based on the expected arrival time (i.e., every 16.67 ms) may be the optimal configuration for most of the video frames. In a limited number of cases, frames may arrive after the OnDuration is expired; however, DRST may recover these unlikely events by extending the Active Time of the user beyond the OnDuration.

FIG. 10 illustrates an example of a system according to certain example embodiments. In one example embodiment, a system may include multiple devices, such as, for example, NE 1010 and/or UE 1020.

NE 1010 may be one or more of a base station, such as an eNB or gNB, a serving gateway, a server, and/or any other access node or combination thereof.

NE 1010 may further comprise at least one gNB-CU, which may be associated with at least one gNB-DU. The at least one gNB-CU and the at least one gNB-DU may be in communication via at least one F1 interface, at least one Xₙ-C interface, and/or at least one NG interface via a 5GC.

UE 1020 may include one or more of a mobile device, such as a mobile phone, smart phone, personal digital assistant (PDA), tablet, or portable media player, digital camera, pocket video camera, video game console, navigation unit, such as a global positioning system (GPS) device, desktop or laptop computer, single-location device, such as a sensor or smart meter, or any combination thereof. Furthermore, NE 1010 and/or UE 1020 may be one or more of a citizens broadband radio service device (CBSD).

NE 1010 and/or UE 1020 may include at least one processor, respectively indicated as 1011 and 1021. Processors 1011 and 1021 may be embodied by any computational or data processing device, such as a central processing unit (CPU), application specific integrated circuit (ASIC), or comparable device. The processors may be implemented as a single controller, or a plurality of controllers or processors.

At least one memory may be provided in one or more of the devices, as indicated at 1012 and 1022. The memory may be fixed or removable. The memory may include computer program instructions or computer code contained therein. Memories 1012 and 1022 may independently be any suitable storage device, such as a non-transitory computer-readable medium. The term “non-transitory,” as used herein, is a limitation of the medium itself (i.e., tangible, not a signal) as opposed to a limitation on data storage persistency (e.g., RAM vs. ROM). A hard disk drive (HDD), random access memory (RAM), flash memory, or other suitable memory may be used. The memories may be combined on a single integrated circuit as the processor, or may be separate from the one or more processors. Furthermore, the computer program instructions stored in the memory, and which may be processed by the processors, may be any suitable form of computer program code, for example, a compiled or interpreted computer program written in any suitable programming language.

Processors 1011 and 1021, memories 1012 and 1022, and any subset thereof, may be configured to provide means corresponding to the various blocks of FIGS. 3-6. Although not shown, the devices may also include positioning hardware, such as GPS or micro electrical mechanical system (MEMS) hardware, which may be used to determine a location of the device. Other sensors are also permitted, and may be configured to determine location, elevation, velocity, orientation, and so forth, such as barometers, compasses, and the like.

As shown in FIG. 10, transceivers 1013 and 1023 may be provided, and one or more devices may also include at least one antenna, respectively illustrated as 1014 and 1024. The device may have many antennas, such as an array of antennas configured for multiple input multiple output (MIMO) communications, or multiple antennas for multiple RATs. Other configurations of these devices, for example, may be provided. Transceivers 1013 and 1023 may be a transmitter, a receiver, both a transmitter and a receiver, or a unit or device that may be configured both for transmission and reception.

The memory and the computer program instructions may be configured, with the processor for the particular device, to cause a hardware apparatus, such as UE, to perform any of the processes described above (i.e., FIGS. 3-6). Therefore, in certain example embodiments, a non-transitory computer-readable medium may be encoded with computer instructions that, when executed in hardware, perform a process such as one of the processes described herein. Alternatively, certain example embodiments may be performed entirely in hardware.

In certain example embodiments, an apparatus may include circuitry configured to perform any of the processes or functions illustrated in FIGS. 3-6. For example, circuitry may be hardware-only circuit implementations, such as analog and/or digital circuitry. In another example, circuitry may be a combination of hardware circuits and software, such as a combination of analog and/or digital hardware circuitry with software or firmware, and/or any portions of hardware processors with software (including digital signal processors), software, and at least one memory that work together to cause an apparatus to perform various processes or functions. In yet another example, circuitry may be hardware circuitry and or processors, such as a microprocessor or a portion of a microprocessor, that includes software, such as firmware, for operation. Software in circuitry may not be present when it is not needed for the operation of the hardware.

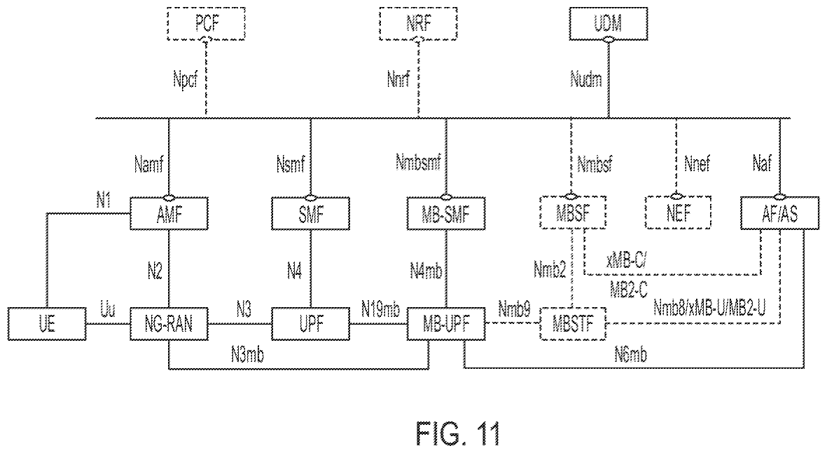

FIG. 11 illustrates an example of a 5G network and system architecture according to certain example embodiments. Shown are multiple network functions that may be implemented as software operating as part of a network device or dedicated hardware, as a network device itself or dedicated hardware, or as a virtual function operating as a network device or dedicated hardware. The NE and UE illustrated in FIG. 11 may be similar to NE 1010 and UE 1020, respectively. The user plane function (UPF) may provide services such as intra-RAT and inter-RAT mobility, routing and forwarding of data packets, inspection of packets, user plane quality of service (QoS) processing, buffering of downlink packets, and/or triggering of downlink data notifications. The application function (AF) may primarily interface with the core network to facilitate application usage of traffic routing and interact with the policy framework.

According to certain example embodiments, processors 1011 and 1021, and memories 1012 and 1022, may be included in or may form a part of processing circuitry or control circuitry. In addition, in some example embodiments, transceivers 1013 and 1023 may be included in or may form a part of transceiving circuitry.

In some example embodiments, an apparatus (e.g., NE 1010 and/or UE 1020) may include means for performing a method, a process, or any of the variants discussed herein. Examples of the means may include one or more processors, memory, controllers, transmitters, receivers, and/or computer program code for causing the performance of the operations.

The features, structures, or characteristics of example embodiments described throughout this specification may be combined in any suitable manner in one or more example embodiments. For example, the usage of the phrases “various embodiments,” “certain embodiments,” “some embodiments,” or other similar language throughout this specification refers to the fact that a particular feature, structure, or characteristic described in connection with an example embodiment may be included in at least one example embodiment. Thus, appearances of the phrases “in various embodiments,” “in certain embodiments,” “in some embodiments,” or other similar language throughout this specification does not necessarily all refer to the same group of example embodiments, and the described features, structures, or characteristics may be combined in any suitable manner in one or more example embodiments.

Additionally, if desired, the different functions or procedures discussed above may be performed in a different order and/or concurrently with each other. Furthermore, if desired, one or more of the described functions or procedures may be optional or may be combined. As such, the description above should be considered as illustrative of the principles and teachings of certain example embodiments, and not in limitation thereof.

One having ordinary skill in the art will readily understand that the example embodiments discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of the example embodiments.

### Partial Glossary

3GPP Third Generation Partnership Project
5G Fifth Generation
5GC Fifth Generation Core
6G Sixth Generation
ASIC Application Specific Integrated Circuit
BS Base Station
CBSD Citizens Broadband Radio Service Device
CDRX Connected Mode Discontinuous Reception
CE Control Elements
CN Core Network
CPU Central Processing Unit
CRC Cyclic Redundancy Check
DCI Downlink Control Information
DCP Dynamic Clustering Protocol
DL Downlink
DRST Discontinuous Rest
DRX Discontinuous Reception
eMBB Enhanced Mobile Broadband
eNB Evolved Node B
EPS Evolved Packet System
FR Frequency Range
GC-PDCCH Group Common Physical Downlink Control Channel
gNB Next Generation Node B
GPS Global Positioning System
HARQ Hybrid Automatic Repeat Request
HDD Hard Disk Drive
L1 Layer 1
L2 Layer 2
LTE Long-Term Evolution
LTE-A Long-Term Evolution Advanced
MAC Medium Access Control
MEMS Micro Electrical Mechanical System
MIMO Multiple Input Multiple Output
MME Mobility Management Entity
1mMTC Massive Machine Type Communication
NE Network Entity
NG Next Generation
NG-eNB Next Generation Evolved Node B
NG-RAN Next Generation Radio Access Network
NR New Radio
NR-U New Radio Unlicensed
PDA Personal Digital Assistance
PDCCH Physical Downlink Control Channel
PDSCH Physical Downlink Shared Channel
PDU Protocol Data Unit
PS-RNTI Power Saving Radio Network Temporary Identifier
RAM Random Access Memory
RAN Radio Access Network
RAT Radio Access Technology
RE Resource Element
RF Radio Frequency
RLC Radio Link Control
RNTI Radio Network Temporary Identifier
RRC Radio Resource Control
RS Reference Signals
SMF Session Management Function
SSSG Search Space Set Group
TB Transport Block
TTI Transmission Time Interval
Tx Transmission
UE User Equipment
UL Uplink
UMTS Universal Mobile Telecommunications System
UPF User Plane Function
URLLC Ultra-Reliable and Low-Latency Communication
UTRAN Universal Mobile Telecommunications System Terrestrial Radio Access Network
WLAN Wireless Local Area Network
XR Extended Reality

1-48. (canceled)

49. A method, comprising:
receiving, by a user equipment, a discontinuous rest configuration; and
starting, by the user equipment, a discontinuous rest timer indicated by the discontinuous rest configuration upon an end of an active time and if a number of packets transmitted and a number of packets received before the expiration of the active time is smaller than a corresponding threshold indicated in the discontinuous rest configuration,
wherein the discontinuous rest timer is associated with a discontinuous reception group.

50. The method of claim 49, wherein the discontinuous rest configuration is received as a layer 1 or layer 2 signal.

51. The method of claim 50, wherein the layer 1 or layer 2 signal is received in a medium access control control element command or a downlink control information.

52. The method of claim 51, wherein the downlink control information or the medium access control control element command or an element of a packet header indicates a last packet of a data burst.

53. The method of claim 52, wherein the element of the packet header comprises a layer 1 or layer 2 packet data unit.

54. An apparatus comprising:
at least one processor; and
at least one memory storing instructions that, when executed by the at least one processor, cause the apparatus at least to:
receive a discontinuous rest configuration; and
start a discontinuous rest timer indicated by the discontinuous rest configuration upon an end of an active time and if a number of packets transmitted and a number of packets received before the expiration of the active time is smaller than a corresponding threshold indicated in the discontinuous rest configuration,
wherein the discontinuous rest timer is associated with a discontinuous reception group.

55. The apparatus of claim 54, wherein the discontinuous rest configuration is received as a layer 1 or layer 2 signal.

56. The apparatus of claim 55, wherein the layer 1 or layer 2 signal is received in a medium access control control element command or a downlink control information.

57. The apparatus of claim 56, wherein the downlink control information or the medium access control control element command or an element of a packet header indicates a last packet of a data burst.

58. The apparatus of claim 57, wherein the element of the packet header comprises a layer 1 or layer 2 packet data unit.

59. The apparatus of claim 54, wherein the discontinuous rest configuration is received in a downlink control information.

60. The apparatus of claim 54, wherein the at least one memory and the computer program code are further configured to, with the at least one processor, cause the apparatus at least to:
monitor a downlink control channel when the discontinuous rest timer is running.

61. The apparatus of claim 54, wherein the active time comprises an on duration timer, an inactivity timer, or a retransmission timer.

62. An apparatus, comprising:
at least one processor; and
at least one memory storing instructions that, when executed by the at least one processor, cause the apparatus at least to:
transmit a discontinuous rest configuration indicating a discontinuous rest timer to begin upon expiration of an end of an active time associated with a discontinuous reception group and if a number of packets transmitted and a number of packets received before the expiration of the active time is smaller than a corresponding threshold indicated in the discontinuous rest configuration.

63. The apparatus of claim 62, wherein the discontinuous rest configuration is transmitted as a layer 1 or layer 2 signal.

64. The apparatus of claim 62, wherein the layer 1 or layer 2 signal is transmitted in a medium access control control element command or a downlink control information.

65. The apparatus of claim 64, wherein the downlink control information or the medium access control control element command or an element of a packet header indicates a last packet of a data burst.

66. The apparatus of claim 65, wherein the element of the packet header comprises a layer 1 or layer 2 packet data unit.

67. The apparatus of claim 62, wherein the discontinuous rest configuration is transmitted via a downlink control information.

68. The apparatus of claim 62, wherein the active time comprises an on duration timer, an inactivity timer, or a retransmission timer.
